(19) United States
(12) Patent Application Publication
(10) Pub. No.: US 2026/0079785 A1
(43) Pub. Date: Mar. 19, 2026

(54) CONTROL DEVICE, ABNORMAL PART IDENTIFICATION METHOD, AND STORAGE MEDIUM

(71) Applicant: TOYOTA JIDOSHA KABUSHIKI KAISHA, Toyota-shi (JP)

(72) Inventor: Sho HORIUCHI, Nagoya-shi (JP)

(73) Assignee: TOYOTA JIDOSHA KABUSHIKI KAISHA, Toyota-shi (JP)

(21) Appl. No.: 19/247,909

(22) Filed: Jun. 24, 2025

(30) Foreign Application Priority Data
Sep. 18, 2024 (JP) 2024-161298

(51) Int. Cl. G06F 11/07

(52) U.S. Cl. CPC G06F 11/079; G06F 11/0736

(57) ABSTRACT

A control device is connected to an electronic device via a signal line. The control device is configured to transmit an abnormal part identification signal to the electronic device via the signal line, calculate, in response to detection of a reflected signal of the abnormal part identification signal, a reflection time from transmission of the abnormal part identification signal to reception of the reflected signal, and identify an abnormal part of the signal line based on the reflection time.

### CROSS-REFERENCE TO RELATED APPLICATION

This application claims priority to Japanese Patent Application No. 2024-161298 filed on Sep. 18, 2024. The disclosure of the above-identified application, including the specification, drawings, and claims, is incorporated by reference herein in its entirety.

### BACKGROUND

### 1. Technical Field

The present disclosure relates to control devices, abnormal part identification methods, and storage media.

### 2. Description of Related Art

Japanese Unexamined Patent Application Publication No. 2013-236162 (JP 2013-236162 A) discloses a cable failure diagnosis device. This cable failure diagnosis device is configured to detect the voltage of a transmitted signal excited by a communication terminal connected to a network cable and the voltage of a reflected signal returned through the network cable, and to automatically determine a failure state of the network cable from the result of dividing the detected voltage values into ranges by a plurality of preset threshold values.

### SUMMARY

The above cable failure diagnosis device can diagnose whether a cable has failed, but cannot identify a part of the cable where the failure has occurred (abnormal part).

The present disclosure provides a technique for identifying an abnormal part of a signal line such as a cable.

According to an aspect of the present disclosure, a control device connected to an electronic device via a signal line is configured to
transmit an abnormal part identification signal to the electronic device via the signal line, in response to detection of a reflected signal of the abnormal part identification signal, calculate a reflection time from transmission of the abnormal part identification signal to reception of the reflected signal, and
identify an abnormal part of the signal line based on the reflection time.

According to an aspect of the present disclosure, a method for identifying an abnormal part of a signal line by a control device connected to an electronic device via the signal line includes:
transmitting an abnormal part identification signal to the electronic device via the signal line;
in response to detection of a reflected signal of the abnormal part identification signal, calculating a reflection time from transmission of the abnormal part identification signal to reception of the reflected signal; and
identifying the abnormal part of the signal line based on the reflection time.

According to an aspect of the present disclosure, in a storage medium storing a computer program for a control device connected to an electronic device via a signal line, the computer program causes the control device to
transmit an abnormal part identification signal to the electronic device via the signal line, in response to detection of a reflected signal of the abnormal part identification signal, calculate a reflection time from transmission of the abnormal part identification signal to reception of the reflected signal, and
identify an abnormal part of the signal line based on the reflection time.

According to these aspects of the present disclosure, it is possible to identify an abnormal part of a signal line.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of a control system according to an embodiment of the present disclosure;

FIG. 2 is a cross-sectional view of a signal line according to an embodiment of the present disclosure;

FIG. 3 is a diagram illustrating a method of detecting a reflected signal of an abnormal part identification signal;

FIG. 4 is a diagram showing an abnormal part identification table representing a relation between the reflection time T and the length X; and

FIG. 5 is a flowchart illustrating the details of an abnormal part identification process according to an embodiment of the present disclosure.

### DETAILED DESCRIPTION OF EMBODIMENTS

Hereinafter, embodiments of the present disclosure will be described in detail with reference to the drawings. In the following description, the same reference numerals are given to the same constituent elements.

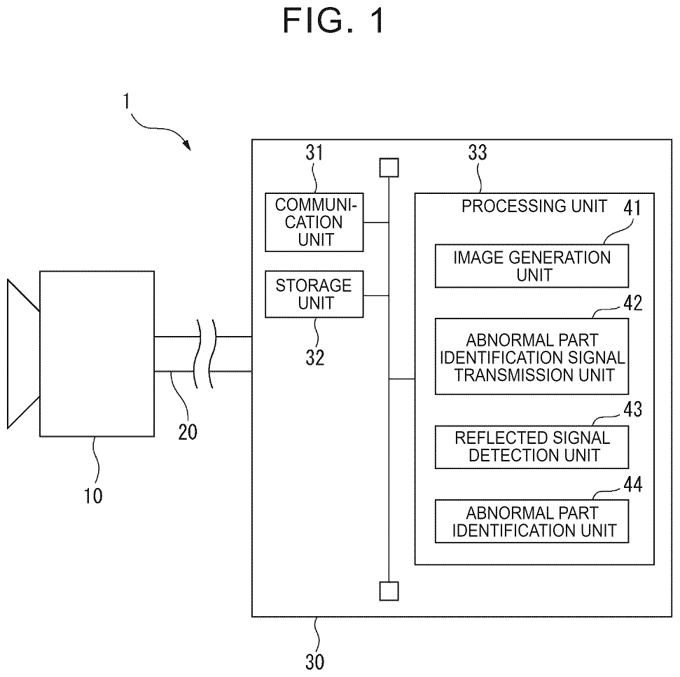

FIG. 1 is a schematic configuration diagram of a control system 1 according to an embodiment of the present disclosure.

The control system 1 includes an electronic device 10, a signal line 20, and a control device 30. In the present embodiment, an advanced driver assistance system (ADAS) mounted on vehicles will be exemplified as the control system 1. However, of course, the control system 1 is not limited to the advanced driver assistance system. Other examples of the control system 1 include, for example, a monitoring system such as a factory.

The electronic device 10 is a device having at least one of a function to acquire data and transmit the data to the control device 30 via the signal line 20 and a function to output data received from the control device 30 via the signal line 20. Examples of the electronic device 10 include a camera, a display, and an audio device. The electronic device 10 according to the present embodiment is an in-vehicle camera that is part of the advanced driver assistance system.

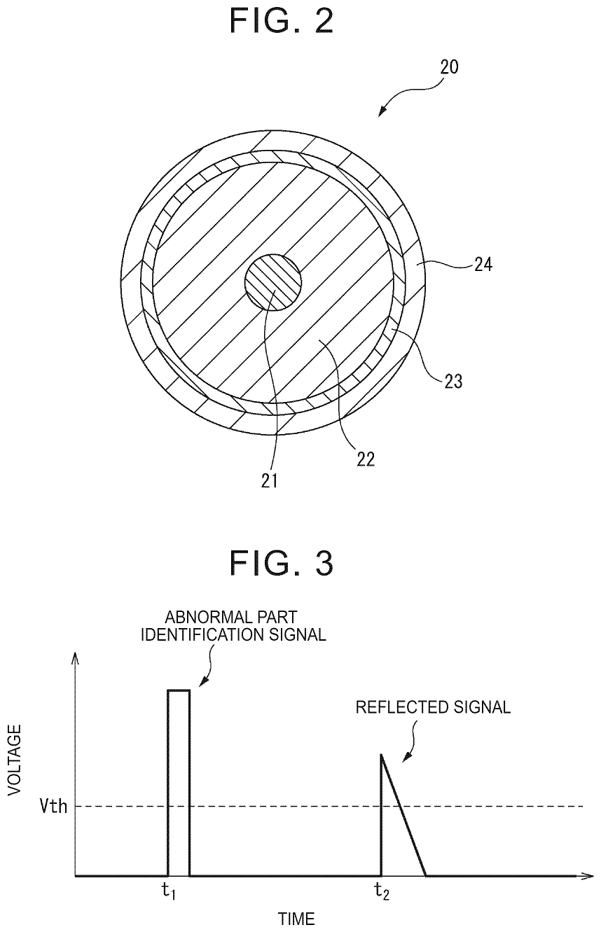

The signal line 20 is constituted by one or more cables having a predetermined characteristic impedance, and transmits a signal by connecting the electronic device 10 and the control device 30. An example of the signal line 20 according to the present embodiment is shown in a cross-sectional view of FIG. 2. The signal line 20 according to the present embodiment is configured by connecting a plurality of coaxial cables including an inner conductor 21, an insulator 22 surrounding the inner conductor 21, an outer conductor 23 surrounding the insulator 22, and an outer coating 24 surrounding the outer conductor 23.

The characteristic impedance of the signal line 20 depends on the internal structure of the signal line 20 such as the outer diameter of the inner conductor 21 and the inner diameter of the outer conductor 23. Therefore, when the signal line 20 is bent or the like and a part thereof is crushed (compressed) and deformed, the outer diameter of the inner conductor 21 and the inner diameter of the outer conductor 23 change in the deformed portion, the characteristic impedance of the deformed portion changes. As a result, the deformed portion of the signal line 20 becomes a characteristic impedance mismatch point, and the transmitted signal is reflected at the mismatch point, so that data communication cannot be performed between the electronic device 10 and the control device 30.

As described above, there is a case where data communication between the electronic device 10 and the control device 30 cannot be performed due to the abnormality of the signal line 20, and therefore it is important to detect whether an abnormality has occurred in the signal line 20. An example of the control system 1 according to the present embodiment is an advanced driver assistance system mounted on a vehicle. Depending on the control system 1, the distance between the electronic device 10 and the control device 30 may be long, or the signal line 20 cannot be routed linearly due to a shield etc. Therefore, the signal line 20 may become long, or a plurality of cables connected together may be used as the signal line 20.

In such a case, it is desirable not only to detect whether an abnormality has occurred in the signal line 20, but also to detect which part of the signal line 20 has an abnormality. Thus, it is possible to quickly identify the abnormal part for repair, or to replace only the cable with an abnormality instead of replacing the entire signal line 20. Therefore, it is possible to reduce the repair time and the number of repair parts. Therefore, it is important not only to detect whether an abnormality has occurred in the signal line 20, but also to detect which part of the signal line 20 has the abnormality.

Therefore, in the present embodiment, the control device 30 can identify the abnormal part of the signal line 20. Hereinafter, a detailed description will be given of a method of identifying an abnormal part of the signal line 20 together with the configuration of the control device 30.

The control device 30 is an ECU (Electronic Control Unit) including a communication unit 31, a storage unit 32, and a processing unit 33.

The communication unit 31 includes an interface circuit for connecting the control device 30 to an electronic device via the signal line 20. Upon receiving the data from the electronic device 10, the communication unit 31 supplies the data to the processing unit 33. For example, in the present embodiment, the communication unit 31 returns the serialized data received from the in-vehicle camera as the electronic device 10 to the original data by the deserializer and supplies the data to the processing unit 33. The communication unit 31 outputs various signals output from the processing unit 33 to the electronic device 10. For example, in the present embodiment, as will be described later, the communication unit 31 outputs an abnormal part identification signal for identifying an abnormal part of the signal line 20 to the electronic device 10.

The storage unit 32 includes a storage medium such as an HDD (Hard Disk Drive), an SSD (Solid Disk Drive), and a semiconductor memory, and stores various computer programs and data to be used for processing in the processing unit 33.

The processing unit 33 includes one or more CPUs (Central Processing Units) and a peripheral circuit thereof, and executes various computer programs stored in the storage unit 32. The processing unit 33 is, for example, a processor. The processing unit 33 functions as an image generation unit 41, an abnormal part identification signal transmission unit 42, a reflected signal detection unit 43, and an abnormal part identification unit 44 by executing processing in accordance with a computer program. Then, it operates as a functional unit (module) that implements a predetermined function. In the following description of the processing, when the subject is any of the functional units 41 to 44, it means that the processing unit 33 executes a program that implements the functional units 41 to 44.

The image generation unit 41 generates an image based on data received from an in-vehicle camera as the electronic device 10.

The abnormal part identification signal transmission unit 42 transmits the abnormal part identification signal from the communication unit 31 to the electronic device 10 via the signal line 20 in response to the fact that the data cannot be received from the electronic device 10 or the data cannot be transmitted to the electronic device 10. The abnormal part identification signal is a signal for identifying an abnormal part (a characteristic impedance mismatch point due to disconnection or bending) of the signal line 20, and is, for example, a rectangular pulse signal. In the present embodiment, the abnormal part identification signal transmission unit 42 transmits the abnormal part identification signal to the in-vehicle camera via the signal line 20 in response to the failure of the electronic device 10 to receive data from the in-vehicle camera.

The reflected signal detection unit 43 detects a reflected signal of the abnormal part identification signal. There may be an abnormal part (characteristic impedance mismatch point due to disconnection or bending) in the signal line 20. In this case, as shown in FIG. 3, the abnormal part identification signal transmission unit 42 transmits the abnormal part identification signal at certain time t1. Then, the abnormal part identification signal is reflected at the abnormal part, and the reflected signal of the abnormal part identification signal is detected at time t2 that is later than time t1. In the present embodiment, as shown in FIG. 3, in order to reduce erroneous detection due to noise etc., the reflected signal detection unit 43 detects a signal whose voltage value is equal to or greater than a predetermined threshold Vth within a predetermined period of time after transmitting the abnormal part identification signal, and detects the signal as a reflected signal.

In response to detection of the reflected signal of the abnormal part identification signal, the abnormal part identification unit 44 calculates a reflection time T (period from time t1 to time t2 in the example of FIG. 3) from transmission of the abnormal part identification signal until the detection of the reflected signal. Then, the abnormal part identification unit 44 identifies the abnormal part of the signal line 20 based on the reflection time T. Specifically, the abnormal part identification unit 44 identifies the abnormal part of the signal line 20 based on the reflection time T in the following manner.

Since the length L of the signal line and the transmission rate V (light speed) of the abnormal part identification signal and the reflected signal are known in advance, Tmax can be given by the following equation (1), where Tmax is the time it takes for the abnormal part identification signal travels back and forth through the signal line 20. The reflection time T can be given by the following equation (2), where X is the length of the signal line 20 from the control device 30 to the abnormal part.

$$\begin{matrix}( Mathematical Expression 1 ) & \\ Tmax = 2 L / V & ( 1 )\end{matrix}$$

$$T = 2 X / V \qquad ( 2 )$$

Based on the above equations (1), (2), the length X of the signal line 20 from the control device 30 to the abnormal part can be given by the following equation (3).

$$\begin{matrix}( Mathematical Expression 2 ) & \\ X = T \times ( L / Tmax ) & ( 3 )\end{matrix}$$

Therefore, for example, the second term on the right side of the above equation (3), that is, L/Tmax is stored in the storage unit 32 in advance. Alternatively, for example, the value of the length L of the signal line and the value of the time Tmax are individually stored in advance in the storage unit 32. Therefore, the abnormal part identification unit 44 can identify the abnormal part by calculating the length X of the signal line 20 from the control device 30 to the abnormal part based on the reflection time T by substituting the calculated reflection time T into the above equation (3).

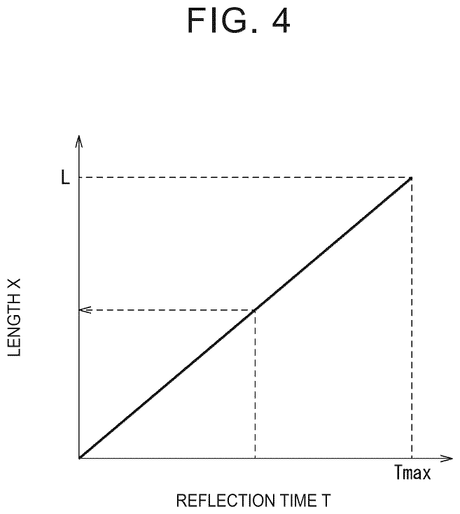

For example, based on the above equation (3), an abnormal part identification table in FIG. 4 showing the relationship between the reflection time T and the length X is created and stored in advance in the storage unit 32. As a result, the abnormal part identification unit 44 can identify the abnormal part by calculating the length X of the signal line 20 from the control device 30 to the abnormal part based on the reflection time T by referring to the abnormal part identification table.

In the present embodiment, when the signal line 20 is a plurality of cables connected together, the length of each cable and the order in which the cables are connected are stored in advance in the storage unit 32. Thus, it is possible to identify a cable with an abnormality from among the plurality of cables based on the length X of the signal line 20 from the control device 30 to the abnormal part.

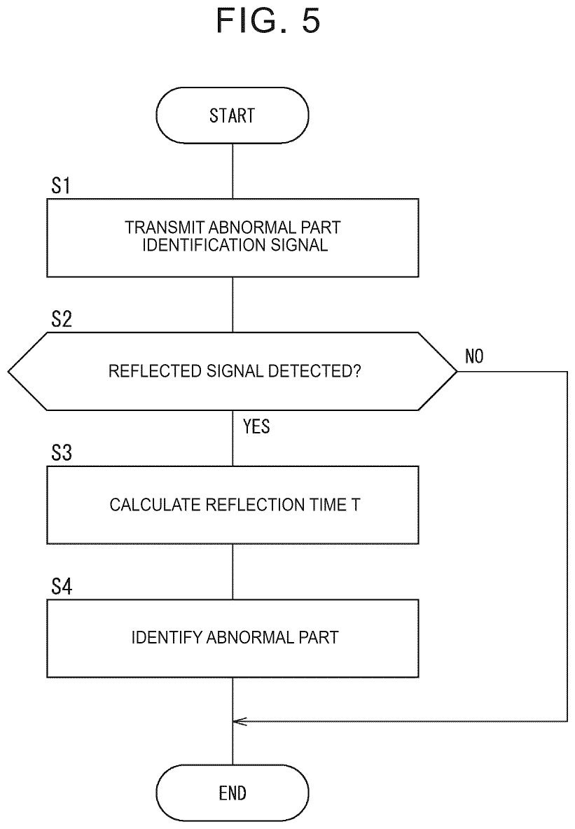

FIG. 5 is a flowchart for explaining the contents of the abnormal part identification processing according to the present embodiment.

In S1, the control device 30 transmits an abnormal part identification signal from the communication unit 31 to the electronic device 10 via the signal line 20 in response to the reception of data from the electronic device 10 or the failure to transmit data to the electronic device 10.

In S2, the control device 30 determines whether the reflected signal of the abnormal part identification signal is detected. As described above, the control device 30 determines that the reflected signal is detected when a signal whose voltage value is equal to or higher than a predetermined threshold Vth is detected within a predetermined period of time after the abnormal part identification signal is transmitted. The predetermined time may be, for example, the time Tmax it takes for the signal to travel back and forth through the signal line 20. When the control device 30 detects the reflected signal of the abnormal part identification signal within a predetermined period, the process proceeds to S2 process. On the other hand, when the reflected signal of the abnormal part identification signal is not detected within the predetermined time, the control device 30 ends the current processing.

In S3, the control device 30 calculates the reflection time T from the transmission of the abnormal part identification signal to the detection of the reflected signal.

In S4, the control device 30 identifies the abnormal part of the signal line 20 based on the reflection time T.

Note that the notification method when an abnormality occurs in the signal line 20 is not particularly limited. For example, the abnormality and the abnormal part of the signal line 20 may be notified to a display device such as a display, not shown, at an arbitrary timing such as a timing at which the abnormality is detected. In addition, when a failure diagnosis tool or the like is connected to the control device 30, an abnormality and an abnormal part of the signal line 20 may be notified on the failure diagnosis tool.

The control device 30 according to the present embodiment described above is connected to the electronic device 10 via the signal line 20, and is configured to transmit an abnormal part identification signal to the electronic device 10 via the signal line 20, calculate, in response to detection of a reflected signal of the abnormal part identification signal, a reflection time T from transmission of the abnormal part identification signal to reception of the reflected signal, and identify an abnormal part of the signal line 20 based on the reflection time T. Specifically, the control device 30 according to the present embodiment is configured to identify the abnormal part of the signal line 20 by calculating the length X of the signal line 20 from the control device 30 to the abnormal part based on the reflection time T.

As described above, according to the present embodiment, the position of the abnormal part of the signal line 20 can be identified. Therefore, it is possible to quickly identify the abnormal part and perform repair. In addition, when the signal line 20 is a plurality of cables connected together, it is possible to replace only a cable with an abnormality instead of replacing the entire signal line 20. Therefore, it is possible to reduce the repair time and reduce the number of repair parts when an abnormality occurs in the signal line 20.

Further, in the present embodiment, the signal line 20 is configured by connecting a plurality of cables. Further, in the present embodiment, the control device 30 is further configured to identify a cable with an abnormality from among the plurality of cables based on the length X of the signal line 20 from the control device 30 to the abnormal part and the lengths of the cables.

As a result, it is possible to quickly identify the cable with an abnormality for repair or replacement, which further reduces the repair time and reducing the number of repair parts.

Although the embodiments of the present disclosure have been described above, the embodiments are merely a part of application examples of the present disclosure and are not intended to limit the technical scope of the present disclosure to the specific configurations of the above embodiments.

For example, in the above embodiment, the computer program that is executed by the control device 30 may be provided in a form recorded on a computer-readable portable recording medium such as a semiconductor memory, a magnetic recording medium, or an optical recording medium, or may be provided as a computer program product.

What is claimed is:

1. A control device connected to an electronic device via a signal line, wherein the control device is configured to
transmit an abnormal part identification signal to the electronic device via the signal line,
in response to detection of a reflected signal of the abnormal part identification signal, calculate a reflection time from transmission of the abnormal part identification signal to reception of the reflected signal, and
identify an abnormal part of the signal line based on the reflection time.

2. The control device according to claim 1, wherein the control device is configured to identify the abnormal part of the signal line by calculating, based on the reflection time, a length of the signal line from the control device to the abnormal part.

3. The control device according to claim 1, wherein:
the signal line is a plurality of cables connected together; and
the control device is further configured to identify a cable with an abnormality from among the cables, based on a length of the signal line from the control device to the abnormal part and lengths of the cables.

4. A method for identifying an abnormal part of a signal line by a control device connected to an electronic device via the signal line, the method comprising:
transmitting an abnormal part identification signal to the electronic device via the signal line;
in response to detection of a reflected signal of the abnormal part identification signal, calculating a reflection time from transmission of the abnormal part identification signal to reception of the reflected signal; and
identifying the abnormal part of the signal line based on the reflection time.

5. A non-transitory storage medium storing a computer program for a control device connected to an electronic device via a signal line, wherein the computer program causes the control device to
transmit an abnormal part identification signal to the electronic device via the signal line,
in response to detection of a reflected signal of the abnormal part identification signal, calculate a reflection time from transmission of the abnormal part identification signal to reception of the reflected signal, and
identify an abnormal part of the signal line based on the reflection time.
